(19) United States
(12) Patent Application Publication
(10) Pub. No.: US 2016/0354744 A1
(43) Pub. Date: Dec. 8, 2016

(54) DISPERSING AGENT, A METHOD FOR MANUFACTURING A DISPERSING AGENT, AN INK, AND A METHOD FOR FORMING AN ELECTRICALLY CONDUCTIVE PATTERN

(71) Applicant: Masahiro YANAGISAWA, Kanagawa (JP)

(72) Inventor: Masahiro YANAGISAWA, Kanagawa (JP)

(73) Assignee: RICOH COMPANY, LTD., Tokyo (JP)

(21) Appl. No.: 15/238,447

(22) Filed: Aug. 16, 2016

Related U.S. Application Data
(62) Division of application No. 14/174,283, filed on Feb. 6, 2014.

(30) Foreign Application Priority Data
Mar. 15, 2013 (JP) 2013-053966

(51) Int. Cl. B01F 17/00; C09D 11/52

(52) U.S. Cl. CPC B01F 17/0028; C09D 11/52; B01F 17/005; B01F 17/0057; B01F 17/0064

(57) ABSTRACT

Disclosed is a dispersing agent to be used for dispersing metal particles, comprising a structural unit originating from a compound represented by a general formula of

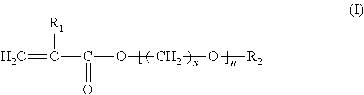

wherein R₁ is a hydrogen atom or a methyl group, R₂ is a hydrogen atom, an alkyl group with a carbon number equal to or greater than 1 and equal to or less than 9, a phenyl group, a bicyclopentenyl group, or a nonylphenyl group, x is 2 or 3, and n is equal to or greater than 1, and a structural unit that has an ionic group, wherein a number average molecular weight of the compound represented by general formula (I) is equal to or less than 10000.

### BACKGROUND OF THE INVENTION

1. Field of the Invention

An aspect of the present invention relates to at least one of a dispersing agent, a method for manufacturing a dispersing agent, an ink, and a method for forming an electrically conductive pattern.

2. Description of the Related Art

Conventionally, lithography, etching, or the like has mainly been utilized as a method for forming an electrically conductive pattern such as a wiring or an antenna on a substrate but there is a problem in the number of steps of a process, efficiency of use of a material, or the like, and manufacturing cost is also high.

Then, a method has been known for forming an electrically conductive pattern by using a printing method such as an inkjet printing method (see, for example, Japanese Patent Application Publication No. 2008-060544).

An inkjet printing method is a method in which an ink is jetted onto a substrate by using an inkjet method and subsequently dried and cured.

For an ink, a nano-metal ink has been known in which metal particles with a primary particle diameter of nm order are dispersed in a dispersion medium.

Japanese Patent Application Publication No. 2010-528428 discloses, as a method for forming an electrically conductive film, a method that includes a step of depositing a film that contains a plurality of copper nanoparticles onto a surface of a substrate and a step of exposing at least one portion of the film with light to provide an electrically conductive light-exposed portion. Herein, a film is deposited from a solution that contains copper nanoparticles, a solvent, and a dispersing agent.

However, there is a problem that a volume resistivity of a light-exposed portion is high.

### SUMMARY OF THE INVENTION

According to one aspect of the present invention, there is provided a dispersing agent to be used for dispersing metal particles, including a structural unit originating from a compound represented by a general formula of

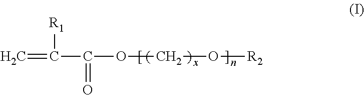

wherein R₁ is a hydrogen atom or a methyl group, R₂ is a hydrogen atom, an alkyl group with a carbon number equal to or greater than 1 and equal to or less than 9, a phenyl group, a bicyclopentenyl group, or a nonylphenyl group, x is 2 or 3, and n is equal to or greater than 1, and a structural unit that has an ionic group, wherein a number average molecular weight of the compound represented by general formula (I) is equal to or less than 10000.

According to another aspect of the present invention, there is provided a method for manufacturing a dispersing agent to be used for dispersing metal particles, including a step of polymerizing a composition that includes a compound represented by a general formula of

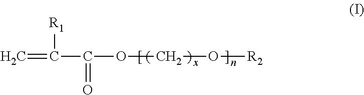

wherein R₁ is a hydrogen atom or a methyl group, R₂ is a hydrogen atom, an alkyl group with a carbon number equal to or greater than 1 and equal to or less than 9, a phenyl group, a bicyclopentenyl group, or a nonylphenyl group, x is 2 or 3, and n is a natural number, and a monomer that has an ionic group, wherein a number average molecular weight of the compound represented by general formula (I) is equal to or less than 10000.

According to another aspect of the present invention, there is provided an ink to be used for forming an electrically conductive pattern, wherein the ink includes the dispersing agent as described above, metal particles, and a dispersion medium.

According to another aspect of the present invention, there is provided a method for forming an electrically conductive pattern, comprising a step of applying the ink as described above onto a substrate, and a step of curing the ink applied on the substrate.

### DETAILED DESCRIPTION OF THE PREFERRED EMBODIMENTS

Next, an embodiment(s) of the present invention will be described.

A dispersing agent has a structural unit originating from a compound represented by general formula (I) and a structural unit that has an ionic group, and is used for dispersion of a metal particle.

Because a dispersing agent has a group represented by a general formula of:

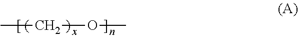

as a side chain, it is considered that decomposition thereof is readily made at time of curing and it is possible to form an electrically conductive pattern with a low volume resistivity. Here, a group represented by general formula (A) also contributes a solubility in a dispersion medium for dispersing a metal particle.

A number average molecular weight of a compound represented by general formula (I) is equal to or less than 10000 and it is preferable to be equal to or less than 5000. If a number average molecular weight of a compound represented by general formula (I) is greater than 10000, it is not possible to form an electrically conductive pattern with a low volume resistivity because a solubility in a dispersion medium for dispersing a metal particle is lowered.

Here, a number average molecular weight is a polystyrene equivalent molecular weight that is measured by using a GPC.

A compound represented by general formula (I) is not particularly limited and it is possible to list a methacrylate-type monomer such as a polyethylene glycol methyl ether methacrylate, an ethylene glycol methyl ether methacrylate, a diethylene glycol methyl ether methacrylate, an ethylene glycol phenyl ether methacrylate, a triethylene glycol methyl ether methacrylate, or a polyethylene glycol ethyl ether methacrylate; or an acrylate-type monomer such as an ethylene glycol methyl ether acrylate, an ethylene glycol phenyl ether acrylate, a diethylene glycol ethyl ether acrylate, a polyethylene glycol methyl ether acrylate, an ethylene glycol dicyclopentenyl ether acrylate, a diethylene glycol 2-ethylhexyl ether acrylate, a polypropylene glycol 4-nonylphenyl ether acrylate, a polyethylene glycol phenyl ether acrylate, a polypropylene glycol methyl ether acrylate, or a polypropylene glycol monoacrylate.

On the other hand, because a dispersing agent has a structural unit that has an ionic group, it is possible to be adsorbed onto a metal particle. Here, because a dispersing agent has a polymer chain, it is possible to suppress aggregation of a metal particle due to a steric hindrance.

An ionic group is not particularly limited and it is possible to list an amino group and a salt thereof, a carboxyl group and a salt thereof, a sulfo group and a salt thereof, a phospho group and a salt thereof, or the like, wherein two kinds or more than two kinds thereof may be used in combination. Among the above, an amino group, a carboxyl group, a sulfo group, or a phospho group is preferable from the viewpoint of an adsorption property with respect to a metal particle.

It is possible to synthesize a dispersing agent by polymerizing a composition that includes a compound represented by general formula (I) and a monomer that has an ionic group.

Here, in a case where an ionic group is a salt of an amino group, a carboxyl group, a sulfo group, or a phospho group, a dispersing agent may be synthesized by polymerizing and subsequently neutralizing a composition that includes a compound represented by general formula (I) and a monomer that has an amino group, a carboxyl group, a sulfo group, or a phospho group.

A monomer that has an amino group is not particularly limited and it is possible to list an N-methylaminoethyl (meth)acrylate, an N-ethylaminoethyl (meth)acrylate, an N,N-dimethylaminoethyl (meth)acrylate, an N,N-diethylaminoethyl (meth)acrylate, an N,N-dibutylaminoethyl acrylate, an N,N-di-tert-butylaminoethyl acrylate, an N-phenylaminoethyl methacrylate, an N,N-diphenylaminoethyl methacrylate, an allylamine, a 4-aminostyrene, a 4-N,N-dimethylaminostyrene, an N-methylaminoethyl styrene, a dimethylaminoethoxystyrene, a diphenylaminoethylstyrene, an N-phenylaminoethylstyrene, a 2-N-piperidylethyl (meth)acrylate, a 2-vinylpyridine, a 4-vinylpyridine, a 2-vinyl-6-methylpyridine, or the like.

A monomer that has a carboxyl group is not particularly limited and it is possible to list an(a) (meth)acrylic acid, a maleic acid, a maleic anhydride, an itaconic acid, an itaconic anhydride, a fumaric acid, a cinnamic acid, a crotonic acid, a vinylbenzoic acid, a 2-methacryloxyethylsuccinic acid, a 2-methacryloxyethylmaleic acid, a 2-methacryloxyethyl hexahydrophthalic acid, a 2-methacryloxyethyltrimellitic acid, or the like.

A monomer that has a sulfo group is not particularly limited and it is possible to list a vinylsulfonic acid, an allylsulfonic acid, a styrenesulfonic acid, a 2-acrylamide-2-methylpropanesulfonic acid, or the like.

A monomer that has a phospho group is not particularly limited and it is possible to list a 3-(meth)acryloxypropylphosphonic acid, or the like.

It is possible to appropriately determine a molar ratio of a compound represented by general formula (I) for a monomer that has an ionic group when a dispersing agent is synthesized, based on a balance between an adsorption property with respect to a metal particle in the dispersing agent and a steric hindrance, and usually, 9-999 is provided.

An ink includes the aforementioned dispersing agent, a metal particle, and a dispersion medium, and is used for formation of an electrically conductive pattern.

A dispersion medium is not particularly limited as long as it is possible to disperse a metal particle, and it is possible to list an organic solvent. Among the above, a polar organic solvent is preferable from the viewpoint of a solubility of a dispersing agent, and a monoalkyl glycol ether, a glycol monoalkyl ether ester, or a dialkyl glycol ether is more preferable.

A monoalkyl glycol ether is not particularly limited and it is possible to list an ethylene-glycol-type ether such as an ethylene glycol monomethyl ether, an ethylene glycol monoethyl ether, an ethylene glycol monopropyl ether, an ethylene glycol monobutyl ether, an ethylene glycol monohexyl ether, an ethylene glycol monophenyl ether, an ethylene glycol mono-2-ethylbutyl ether, a diethylene glycol monomethyl ether, a diethylene glycol monoethyl ether, a diethylene glycol monopropyl ether, a diethylene glycol monobutyl ether, or a diethylene glycol monohexyl ether; or a propylene-glycol-type ether such as a propylene glycol monomethyl ether, a propylene glycol monoethyl ether, a propylene glycol monopropyl ether, a propylene glycol monobutyl ether, a propylene glycol monophenyl ether, a dipropylene glycol monomethyl ether, a dipropylene glycol monoethyl ether, a dipropylene glycol monopropyl ether, a tripropylene glycol monomethyl ether, or a tripropylene glycol monobutyl ether.

A glycol monoalkyl ether ester is not particularly limited and it is possible to list a diethylene glycol monomethyl ether acetate, a diethylene glycol monoethyl ether acetate, a diethylene glycol monobutyl ether acetate, or the like.

A dialkyl glycol ether is not particularly limited and it is possible to list an ethylene glycol dimethyl ether, an ethylene glycol diethyl ether, a diethylene glycol dimethyl ether, a triethylene glycol dimethyl ether, a tetraethylene glycol dimethyl ether, a dipropylene glycol dimethyl ether, or the like.

A metal particle is not particularly limited as long as it is possible to form an electrically conductive pattern, and it is possible to list a copper particle, a silver particle, a nickel particle, or the like.

An average particle diameter of a metal particle is usually 2-100 nm.

Here, it is possible to measure an average particle diameter of a metal particle by using a dynamic light scattering method.

A dispersion machine to be used for dispersing a metal particle in a dispersion medium is not particularly limited and it is possible to list a homogenizer, a ball mill, a sand mill, an attritor, or the like.

A method for formation of an electrically conductive pattern has a step of applying the aforementioned ink onto a substrate and a step of curing the ink applied on the substrate.

A method for application of an ink is not particularly limited and it is possible to list a spin coat method, an inkjet method, a gravure printing method, a screen printing method, or the like. Among the above, an inkjet method is preferable from the viewpoint of enabling direct patterning.

As an ink applied on a substrate is cured, metal particles are fused with one another so that it is possible to cause an interface between the metal particles to disappear.

A method for curing an ink applied on a substrate is not particularly limited as long as it is possible to fuse metal particles with one another, and it is possible to list heat curing, light curing, or the like. Among the above, light curing is preferable from the viewpoint of enabling to suppress damage on a substrate.

A temperature for light-curing an ink applied on a substrate is usually equal to or less than 200° C.

A light source to be used for light curing is not particularly limited and it is possible to list a xenon lamp or the like.

Here, it is preferable to heat and dry an ink applied on a substrate before being cured.

The present invention will be described in more detail by means of a practical example. However, the present invention is not limited to such a practical example. Here, a “part” is a part by mass.

(Synthesis of Dispersing Agent 1)

After 300 parts of ethanol were put into a reactor with an agitator, a thermometer, and a reflux condenser, heating thereof was conducted at 60° C. under purging with nitrogen. Then, after a mixing fluid composed of 90 parts of polyethylene glycol methyl ether methacrylate with a number average molecular weight of 500, 10 parts of methacrylic acid, and a 1 part of azobis(dimethylvaleronitrile) as a polymerization initiator was dropped for 1 hour, agitation thereof was conducted at 60° C. for 5 hours. Furthermore, ethanol was vaporized by using an evaporator to obtain dispersing agent 1.

(Synthesis of Dispersing Agent 2)

Dispersing agent 2 was obtained similarly to dispersing agent 1 except that 95 parts of ethylene glycol methyl ether methacrylate and 5 parts of N,N-dimethylaminoethyl methacrylate were used instead of 90 parts of polyethylene glycol methyl ether methacrylate with a number average molecular weight of 500 and 10 parts of methacrylic acid.

(Synthesis of Dispersing Agent 3)

Dispersing agent 3 was obtained similarly to dispersing agent 1 except that 99 parts of diethylene glycol methyl ether methacrylate and 1 part of 2-acrylamide-2-methylpropanesulfonic acid were used instead of 90 parts of polyethylene glycol methyl ether methacrylate with a number average molecular weight of 500 and 10 parts of methacrylic acid.

(Synthesis of Dispersing Agent 4)

Dispersing agent 4 was obtained similarly to dispersing agent 1 except that 90 parts of ethylene glycol phenyl ether methacrylate and 10 parts of 3-methacryloxypropylphosphonic acid were used instead of 90 parts of polyethylene glycol methyl ether methacrylate with a number average molecular weight of 500 and 10 parts of methacrylic acid.

(Synthesis of Dispersing Agent 5)

Dispersing agent 5 was obtained similarly to dispersing agent 1 except that 95 parts of triethylene glycol methyl ether methacrylate and 5 parts of methacrylic acid were used instead of 90 parts of polyethylene glycol methyl ether methacrylate with a number average molecular weight of 500 and 10 parts of methacrylic acid.

(Synthesis of Dispersing Agent 6)

Dispersing agent 6 was obtained similarly to dispersing agent 1 except that 99 parts of polyethylene glycol ethyl ether methacrylate with a number average molecular weight of 500 and 1 part of N,N-diethylaminoethyl methacrylate were used instead of 90 parts of polyethylene glycol methyl ether methacrylate with a number average molecular weight of 500 and 10 parts of methacrylic acid.

(Synthesis of Dispersing Agent 7)

Dispersing agent 7 was obtained similarly to dispersing agent 1 except that 90 parts of ethylene glycol methyl ether acrylate and 10 parts of acrylic acid were used instead of 90 parts of polyethylene glycol methyl ether methacrylate with a number average molecular weight of 500 and 10 parts of methacrylic acid.

(Synthesis of Dispersing Agent 8)

Dispersing agent 8 was obtained similarly to dispersing agent 1 except that 95 parts of ethylene glycol phenyl ether acrylate and 5 parts of N,N-diethylaminoethyl methacrylate were used instead of 90 parts of polyethylene glycol methyl ether methacrylate with a number average molecular weight of 500 and 10 parts of methacrylic acid.

(Synthesis of Dispersing Agent 9)

Dispersing agent 9 was obtained similarly to dispersing agent 1 except that 99 parts of diethylene glycol ethyl ether acrylate and 1 part of acrylic acid were used instead of 90 parts of polyethylene glycol methyl ether methacrylate with a number average molecular weight of 500 and 10 parts of methacrylic acid.

(Synthesis of Dispersing Agent 10)

Dispersing agent 10 was obtained similarly to dispersing agent 1 except that 90 parts of polyethylene glycol methyl ether acrylate with a number average molecular weight of 480 and 10 parts of allylamine were used instead of 90 parts of polyethylene glycol methyl ether methacrylate with a number average molecular weight of 500 and 10 parts of methacrylic acid.

(Synthesis of Dispersing Agent 11)

Dispersing agent 11 was obtained similarly to dispersing agent 1 except that 95 parts of ethylene glycol dicyclopentenyl ether acrylate and 5 parts of acrylic acid were used instead of 90 parts of polyethylene glycol methyl ether methacrylate with a number average molecular weight of 500 and 10 parts of methacrylic acid.

(Synthesis of Dispersing Agent 12)

Dispersing agent 12 was obtained similarly to dispersing agent 1 except that 99 parts of diethylene glycol 2-ethylhexyl ether acrylate and 1 part of 4-aminostyrene were used instead of 90 parts of polyethylene glycol methyl ether methacrylate with a number average molecular weight of 500 and 10 parts of methacrylic acid.

(Synthesis of Dispersing Agent 13)

Dispersing agent 13 was obtained similarly to dispersing agent 1 except that 90 parts of polyethylene glycol 4-nonylphenyl ether acrylate with a number average molecular weight of 419 and 10 parts of acrylic acid were used instead of 90 parts of polyethylene glycol methyl ether methacrylate with a number average molecular weight of 500 and 10 parts of methacrylic acid.

(Synthesis of Dispersing Agent 14)

Dispersing agent 14 was obtained similarly to dispersing agent 1 except that 95 parts of polyethylene glycol phenyl ether acrylate with a number average molecular weight of 324 and 5 parts of 4-vinylpyridine were used instead of 90 parts of polyethylene glycol methyl ether methacrylate with a number average molecular weight of 500 and 10 parts of methacrylic acid.

(Synthesis of Dispersing Agent 15)

Dispersing agent 15 was obtained similarly to dispersing agent 1 except that 99 parts of polypropylene glycol methyl ether acrylate with a number average molecular weight of 260 and 1 part of acrylic acid were used instead of 90 parts of polyethylene glycol methyl ether methacrylate with a number average molecular weight of 500 and 10 parts of methacrylic acid.

(Synthesis of Dispersing Agent 16)

Dispersing agent 16 was obtained similarly to dispersing agent 1 except that 90 parts of polypropylene glycol monoacrylate with a number average molecular weight of 475 and 10 parts of N,N-dibutylaminoethyl acrylate were used instead of 90 parts of polyethylene glycol methyl ether methacrylate with a number average molecular weight of 500 and 10 parts of methacrylic acid.

### Practical Example 1

After 5 parts of dispersing agent 1, 40 parts of QSI-Nano Copper Powder (produced by Quantum Sphere Ltd.) as copper particles, and 100 parts of ethylene glycol monomethyl ether were ultrasonically dispersed for 10 minutes, dispersion thereof was conducted by using FILMIX (produced by PRIMIX Corporation) as a high-speed mixer for 10 minutes. Then, coarse particles were removed by using a filter with a pore size of 1 μm to obtain an ink with an average particle diameter of 75 nm.

### Practical Example 2

An ink with an average particle diameter of 69 nm was obtained similarly to Practical Example 1 except that 2 parts of dispersing agent 2 were used instead of 5 parts of dispersing agent 1 and diethylene glycol monoethyl ether was used instead of ethylene glycol monomethyl ether.

### Practical Example 3

An ink with an average particle diameter of 83 nm was obtained similarly to Practical Example 1 except that 10 parts of dispersing agent 3 were used instead of 5 parts of dispersing agent 1 and diethylene glycol monobutyl ether acetate was used instead of ethylene glycol monomethyl ether.

### Practical Example 4

An ink with an average particle diameter of 82 nm was obtained similarly to Practical Example 1 except that 10 parts of dispersing agent 4 were used instead of 5 parts of dispersing agent 1 and triethylene glycol dimethyl ether was used instead of ethylene glycol monomethyl ether.

### Practical Example 5

An ink with an average particle diameter of 68 nm was obtained similarly to Practical Example 1 except that dispersing agent 5 was used instead of dispersing agent 1 and dipropylene glycol monomethyl ether was used instead of ethylene glycol monomethyl ether.

### Practical Example 6

An ink with an average particle diameter of 73 nm was obtained similarly to Practical Example 1 except that 2 parts of dispersing agent 6 were used instead of 5 parts of dispersing agent 1 and tripropylene glycol monomethyl ether was used instead of ethylene glycol monomethyl ether.

### Practical Example 7

An ink with an average particle diameter of 82 nm was obtained similarly to Practical Example 1 except that 10 parts of dispersing agent 7 were used instead of 5 parts of dispersing agent 1 and diethylene glycol monoethyl ether acetate was used instead of ethylene glycol monomethyl ether.

### Practical Example 8

An ink with an average particle diameter of 79 nm was obtained similarly to Practical Example 1 except that dispersing agent 8 was used instead of dispersing agent 1 and ethylene glycol monopropyl ether was used instead of ethylene glycol monomethyl ether.

### Practical Example 9

An ink with an average particle diameter of 85 nm was obtained similarly to Practical Example 1 except that 2 parts of dispersing agent 9 were used instead of 5 parts of dispersing agent 1 and propylene glycol monophenyl ether was used instead of ethylene glycol monomethyl ether.

### Practical Example 10

An ink with an average particle diameter of 91 nm was obtained similarly to Practical Example 1 except that 10 parts of dispersing agent 10 were used instead of 5 parts of dispersing agent 1 and diethylene glycol diethyl ether was used instead of ethylene glycol monomethyl ether.

### Practical Example 11

An ink with an average particle diameter of 93 nm was obtained similarly to Practical Example 1 except that dispersing agent 11 was used instead of dispersing agent 1 and triethylene glycol monomethyl ether was used instead of ethylene glycol monomethyl ether.

### Practical Example 12

An ink with an average particle diameter of 87 nm was obtained similarly to Practical Example 1 except that 2 parts of dispersing agent 12 were used instead of 5 parts of dispersing agent 1 and propylene glycol monomethyl ether acetate was used instead of ethylene glycol monomethyl ether.

### Practical Example 13

An ink with an average particle diameter of 92 nm was obtained similarly to Practical Example 1 except that 10 parts of dispersing agent 13 were used instead of 5 parts of dispersing agent 1 and diethylene glycol dimethyl ether was used instead of ethylene glycol monomethyl ether.

### Practical Example 14

An ink with an average particle diameter of 71 nm was obtained similarly to Practical Example 1 except that dispersing agent 14 was used instead of dispersing agent 1 and dipropylene glycol monobutyl ether was used instead of ethylene glycol monomethyl ether.

### Practical Example 15

An ink with an average particle diameter of 74 nm was obtained similarly to Practical Example 1 except that 2 parts of dispersing agent 15 were used instead of 5 parts of dispersing agent 1 and ethylene glycol monobutyl ether acetate was used instead of ethylene glycol monomethyl ether.

### Practical Example 16

An ink with an average particle diameter of 96 nm was obtained similarly to Practical Example 1 except that 10 parts of dispersing agent 16 were used instead of 5 parts of dispersing agent 1 and propylene glycol monophenyl ether was used instead of ethylene glycol monomethyl ether.

### Comparative Example 1

An ink with an average particle diameter of 90 nm was obtained similarly to Practical Example 1 except that poly(vinylpyrrolidone) was used instead of dispersing agent 1 and ethylene glycol was used instead of ethylene glycol monomethyl ether.

### Comparative Example 2

An ink with an average particle diameter of 125 nm was obtained similarly to Practical Example 1 except that poly(vinyl alcohol) was used instead of dispersing agent 1 and isopropyl alcohol was used instead of ethylene glycol monomethyl ether.

(Average Particle Diameter)

An average particle diameter was measured by using Fiber-Optics Particle Analyzer FPAR-1000 (produced by Otsuka Electronics Co., Ltd.).

(Formation of Electrically Conductive Pattern 1)

After an ink was spin-coated onto a glass substrate, a dispersion medium thereof was vaporized by using a hot plate at 120° C. Then, heating was conducted at 300° C. for 1 hour by using an electric furnace provided with a nitrogen stream to form electrically conductive pattern 1. Furthermore, an electrical resistance and a thickness of electrically conductive pattern 1 were measured by using resistivity meter Rolesta (produced by Mitsubishi Chemical Co., Ltd.) and Alpha-Step (produced by KLA-Tencor Corporation), and a volume resistivity thereof was calculated.

(Formation of Electrically Conductive Pattern 2)

After an ink was patterned on a film with a receiving layer (an OHP sheet) by using an inkjet application device (produced by Ricoh Printing Systems, Ltd.), a dispersion medium thereof was vaporized by using a hot plate at 120° C. Then, irradiation with light for 1 minute was conducted by using a xenon lamp to form electrically conductive pattern 2. Furthermore, an electrical resistance and a thickness of electrically conductive pattern 2 were measured by using resistivity meter Rolesta (produced by Mitsubishi Chemical Co., Ltd.) and Alpha-Step (produced by KLA-Tencor Corporation), and a volume resistivity thereof was calculated.

Table 1 illustrates evaluation results of volume resistivities of electrically conductive patterns 1 and 2.

TABLE 1

| | Electrically conductive pattern | |
|---|---|---|
| | 1 | 2 |
| | Volume resistivity | Volume resistivity |
| | [Ω · cm] | [Ω · cm] |
| Practical | 8 × 10⁻⁶ | 1 × 10⁻⁵ |
| Example 1 | | |
| Practical | 5 × 10⁻⁶ | 1 × 10⁻⁵ |
| Example 2 | | |
| Practical | 7 × 10⁻⁶ | 1 × 10⁻⁵ |
| Example 3 | | |
| Practical | 9 × 10⁻⁶ | 2 × 10⁻⁵ |
| Example 4 | | |
| Practical | 6 × 10⁻⁶ | 1 × 10⁻⁵ |
| Example 5 | | |
| Practical | 6 × 10⁻⁶ | 1 × 10⁻⁵ |
| Example 6 | | |
| Practical | 7 × 10⁻⁶ | 1 × 10⁻⁵ |
| Example 7 | | |
| Practical | 7 × 10⁻⁶ | 2 × 10⁻⁵ |
| Example 8 | | |
| Practical | 9 × 10⁻⁶ | 1 × 10⁻⁵ |
| Example 9 | | |
| Practical | 6 × 10⁻⁶ | 1 × 10⁻⁵ |
| Example 10 | | |
| Practical | 8 × 10⁻⁶ | 1 × 10⁻⁵ |
| Example 11 | | |
| Practical | 8 × 10⁻⁶ | 1 × 10⁻⁵ |
| Example 12 | | |
| Practical | 9 × 10⁻⁶ | 2 × 10⁻⁵ |
| Example 13 | | |
| Practical | 8 × 10⁻⁶ | 1 × 10⁻⁵ |
| Example 14 | | |
| Practical | 9 × 10⁻⁶ | 1 × 10⁻⁵ |
| Example 15 | | |
| Practical | 1 × 10⁻⁵ | 2 × 10⁻⁵ |
| Example 16 | | |
| Comparative | 8 × 10⁻³ | 4 × 10⁻² |
| Example 1 | | |
| Comparative | 5 × 10⁻² | 1 × 10⁻¹ |
| Example 2 | | |

It is found from Table 1 that the inks in Practical Examples 1-16 were such that a volume resistivity of an electrically conductive pattern was low in any case of heat curing and light curing.

On the other hand, it is found that the ink in Comparative Example 1 was such that a volume resistivity of an electrically conductive pattern was high in any case of heat curing and light curing, because a dispersing agent was difficult to be decomposed and it was difficult to be cured sufficiently. Herein, a high volume resistivity of the electrically conductive pattern was significant in a case of light curing.

Furthermore, it is found that the ink in Comparative Example 2 was such that a volume resistivity of an electrically conductive pattern was high in any case of heat curing and light curing, because it was difficult to form a film with compactly deposited metal particles at a time of application. Herein, a high volume resistivity of the electrically conductive pattern was significant in a case of light curing.

### APPENDIX

<An Illustrative Embodiment(s) of a Dispersing Agent and a Method for Manufacturing it>

At least one illustrative embodiment of the present invention may relate to at least one of a dispersing agent, a method for manufacturing of a dispersing agent, an ink, and a method for formation of an electrically conductive pattern.

An object of at least one illustrative embodiment of the present invention may be to provide a dispersing agent capable of forming an electrically conductive pattern with a low volume resistivity.

At least one illustrative embodiment of the present invention may be a dispersing agent to be used for dispersion of a metal particle, which has a structural unit originating from a compound represented by a general formula of

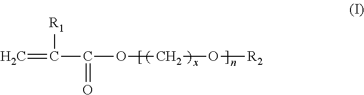

(in the formula, R₁ is a hydrogen atom or a methyl group, R₂ is a hydrogen atom, an alkyl group with a carbon number equal to or greater than 1 and equal to or less than 9, a phenyl group, a bicyclopentenyl group, or a nonylphenyl group, x is 2 or 3, and n is equal to or greater than 1.) and a structural unit that has an ionic group, wherein a number average molecular weight of the compound represented by general formula (I) is equal to or less than 10000.

At least one illustrative embodiment of the present invention may be a method for manufacturing a dispersing agent to be used for dispersion of a metal particle, which has a step of polymerizing a composition that includes a compound represented by a general formula of

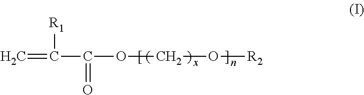

(in the formula, R₁ is a hydrogen atom or a methyl group, R₂ is a hydrogen atom, an alkyl group with a carbon number equal to or greater than 1 and equal to or less than 9, a phenyl group, a bicyclopentenyl group, or a nonylphenyl group, x is 2 or 3, and n is equal to or greater than 1.) and a monomer that has an ionic group, wherein a number average molecular weight of the compound represented by general formula (I) is equal to or less than 10000.

Illustrative Embodiment (1) is a dispersing agent to be used for dispersion of a metal particle, wherein the dispersing agent is characterized by having a structural unit originating from a compound represented by a general formula of

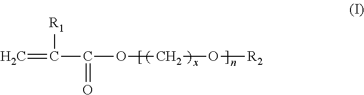

(in the formula, R₁ is a hydrogen atom or a methyl group, R₂ is a hydrogen atom, an alkyl group with a carbon number equal to or greater than 1 and equal to or less than 9, a phenyl group, a bicyclopentenyl group, or a nonylphenyl group, x is 2 or 3, and n is equal to or greater than 1.) and a structural unit that has an ionic group, wherein a number average molecular weight of the compound represented by general formula (I) is equal to or less than 10000.

Illustrative Embodiment (2) is the dispersing agent as described in Illustrative Embodiment (1), characterized in that the ionic group is an amino group, a carboxyl group, a sulfo group, or a phospho group.

Illustrative Embodiment (3) is a method for manufacturing a dispersing agent to be used for dispersion of a metal particle, wherein the method for manufacturing a dispersing agent is characterized by having a step of polymerizing a composition that includes a compound represented by a general formula of

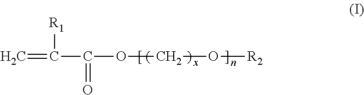

(in the formula, R₁ is a hydrogen atom or a methyl group, R₂ is a hydrogen atom, an alkyl group with a carbon number equal to or greater than 1 and equal to or less than 9, a phenyl group, a bicyclopentenyl group, or a nonylphenyl group, x is 2 or 3, and n is a natural number.) and a monomer that has an ionic group, wherein a number average molecular weight of the compound represented by general formula (I) is equal to or less than 10000.

Illustrative Embodiment (4) is an ink to be used for formation of an electrically conductive pattern, wherein the ink is characterized by including the dispersing agent as described in Illustrative Embodiment (1) or (2), a metal particle, and a dispersion medium.

Illustrative Embodiment (5) is the ink as described in Illustrative Embodiment (4), characterized in that the dispersion medium includes a monoalkyl glycol ether, a glycol monoalkyl ether ester, or a dialkylglycol ether.

Illustrative Embodiment (6) is a method for formation of an electrically conductive pattern, characterized by having a step of applying the ink as described in Illustrative Embodiment (4) or (5) onto a substrate, and a step of curing the ink applied on the substrate.

Illustrative Embodiment (7) is the method for formation of an electrically conductive pattern as described in Illustrative Embodiment (6), characterized in that the ink applied on the substrate is photonic-cured.

According to at least one illustrative embodiment of the present invention, it may be possible to provide a dispersing agent capable of forming an electrically conductive pattern with a low volume resistivity.

Although the illustrative embodiment(s) and/or specific example(s) of the present invention has/have been described with reference to the accompanying drawing(s), the present invention is not limited to any of the illustrative embodiment(s) and/or specific example(s), and the illustrative embodiment(s) and/or specific example(s) may be altered, modified, or combined without departing from the scope of the present invention.

The present application claims the benefit of priority based on Japanese Patent Application No. 2013-053966 filed on Mar. 15, 2013, the entire content(s) of which is/are herein incorporated by reference.

1-7. (canceled)

8. A method for forming an electrically conductive pattern, comprising:
applying an ink onto a substrate, the ink including a dispersing agent, metal particles and a dispersion medium; and
curing the ink applied on the substrate,
the dispersing agent including
a structural unit that has an ionic group, and
a structural unit originating from a compound represented by a general formula of 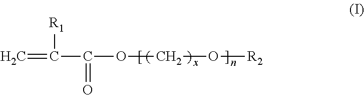
wherein R₁ is a hydrogen atom or a methyl group, R₂ is a hydrogen atom, an alkyl group with a carbon number equal to or greater than 1 and equal to or less than 9, a phenyl group, a bicyclopentenyl group, or a nonylphenyl group, x is 2 or 3, and n is equal to or greater than 1, and
wherein a number average molecular weight of the compound represented by general formula (I) is equal to or less than 10000.

9. The method for forming the electrically conductive pattern as claimed in claim 8, wherein the ionic group is an amino group, a carboxyl group, a sulfo group, or a phospho group.

10. The method for forming the electrically conductive pattern as claimed in claim 8, wherein the dispersion medium includes a monoalkyl glycol ether, a glycol monoalkyl ether ester, or a dialkylglycol ether.

11. The method for forming the electrically conductive pattern as claimed in claim 8, wherein in the applying the ink, the ink is applied by an inkjet printing method.

12. The method for forming the electrically conductive pattern as claimed in claim 8, wherein in the curing the ink, the ink is photonic-cured.

13. A method for forming an electrically conductive pattern, comprising:
manufacturing a dispersing agent;
applying an ink onto a substrate, the ink including the dispersing agent, metal particles and a dispersion medium; and
curing the ink applied on the substrate,
the manufacturing the dispersing agent including polymerizing
a monomer that has an ionic group, and
a composition that includes a compound represented by a general formula of 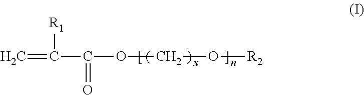
wherein R₁ is a hydrogen atom or a methyl group, R₂ is a hydrogen atom, an alkyl group with a carbon number equal to or greater than 1 and equal to or less than 9, a phenyl group, a bicyclopentenyl group, or a nonylphenyl group, x is 2 or 3, and n is a natural number, and
wherein a number average molecular weight of the compound represented by general formula (I) is equal to or less than 10000.

14. The method for forming the electrically conductive pattern as claimed in claim 13, wherein the ionic group is an amino group, a carboxyl group, a sulfo group, or a phospho group.

15. The method for forming the electrically conductive pattern as claimed in claim 13, wherein the dispersion medium includes a monoalkyl glycol ether, a glycol monoalkyl ether ester, or a dialkylglycol ether.

16. The method for forming the electrically conductive pattern as claimed in claim 13, wherein in the curing the ink, the ink is photonic-cured.

17. The method for forming the electrically conductive pattern as claimed in claim 13, wherein in the applying the ink, the ink is applied by an inkjet printing method.

18. The method for forming the electrically conductive pattern as claimed in claim 13, wherein an average particle diameter of the metal particles is 2 to 100 nm.
